(19) United States
(12) Patent Application Publication
(10) Pub. No.: US 2012/0106024 A1
(43) Pub. Date: May 3, 2012

(54) ELECTROSTATICALLY-ASSISTED CENTRIFUGATION APPARATUS AND RELATED METHODS

(75) Inventor: Joseph M. Conny, Frederick, MD (US)

(73) Assignee: NATIONAL INSTITUTE OF STANDARDS AND TECHNOLOGY, Gaithersburg, MD (US)

(21) Appl. No.: 12/938,636

(22) Filed: Nov. 3, 2010

(51) Int. Cl. H02N 13/00

(52) U.S. Cl. 361/233

(57) ABSTRACT

A particle transfer apparatus and system are described. The apparatus and system enable convenient transfer of particle populations from one substrate to another substrate. The particle transfer system includes components for centrifuging and establishing electrical charges on certain components of the transfer apparatus. The apparatus and system are well suited for transfer of particles from a fibrous matrix to a smooth substrate for subsequent analysis.

### FIELD OF THE INVENTION

The present invention relates to systems and methods of transferring particles from one surface or substrate to another, and particularly while maintaining certain characteristics of particle collections.

### BACKGROUND OF THE INVENTION

Particles in ambient air are often collected on fibrous filters for subsequent analysis in monitoring of air toxins, pollution abatement studies, and studies on the climatic effects of aerosols. When investigating atmospheric particles, it is often desirable to use samples collected using fibrous filters because of the wide availability of such filters. While fibrous filter samples may be suitable for bulk chemical analyses, they are typically unsuitable for electron-beam imaging or x-ray analysis of individual particles.

The charging of filter fibers, and quartz fibers in particular, by an electron beam limits scanning electron microscopy (SEM) imaging to a variable pressure technique in which beam charging is less problematic. However, regardless of the SEM imaging technique, x-ray microanalysis of particles embedded in either a quartz or glass fiber matrix is untenable because the x-rays from particles are typically absorbed or scattered by the fiber matrix. Therefore, problems associated with fibrous filters when using SEM techniques preclude the use of existing quartz-fiber and glass-fiber filter samples that have been archived from several decades of monitoring atmospheric particulate matter.

As noted, fibrous filters are generally unsuitable for imaging or x-ray analysis of individual particles by SEM techniques, and particularly high vacuum SEM. The current practice for acquiring atmospheric particles for SEM is to collect the particles on a capillary pore membrane filter, such as those commercially available under the designation NUCLEPORE®. Although satisfactory, capillary pore membrane filters may be more costly than fibrous filters and not as widely available. In addition, it is often desirable to study individual particles that have already been collected on quartz-fiber or glass-fiber filter samples.

Furthermore, the distribution or pattern of particles on a filter may itself be of significance and of interest for analysis. And so, it would be desirable to provide a technique whereby if such particles were transferred to a substrate suitable for SEM analysis, their pattern of distribution on their former filter or substrate could be retained. As far as is known, there is no technique for transferring collections of particles from fibrous filters which retains the particles' previous pattern. Accordingly, it would be desirable to provide a strategy for transferring particles to a substrate suitable for SEM in a manner whereby the initial distribution of particles on the previous substrate such as a fibrous filter is retained.

### SUMMARY OF THE INVENTION

The difficulties and drawbacks associated with previously known practices are addressed in the present devices, systems, and methods for transferring particles.

In one aspect, the present invention provides a particle transfer apparatus comprising a first charge member defining a first face in the apparatus, with the first charge member adapted for retaining an electrical charge along the first face. The apparatus also comprises a second charge member defining a second face that is directed toward the first face of the first charge member in the apparatus. The second member is adapted for retaining an electrical charge along the second face. The second charge member is spaced from the first charge member. The apparatus also comprises a screen member disposed between the first charge member and the second charge member. The screen member defines a plurality of apertures extending through the screen member. And, the apparatus comprises a receiving substrate disposed between the screen member and the second charge member, the receiving substrate defining a receiving face directed toward the first face of the first charge member.

In another aspect, the invention provides a particle transfer system. The system comprises a centrifuge component and a particle transfer apparatus disposed within the centrifuge component. The particle transfer apparatus includes a pair of spaced apart charge members adapted for retaining an electrical charge, and a receiving substrate disposed between the pair of charge members. The system also comprises a centrifugation system including provisions for performing a centrifugation operation upon the centrifuge component and the particle transfer apparatus.

In still another aspect, the invention provides a method for transferring particles from a first substrate to a second receiving substrate. The method comprises providing a particle transfer apparatus including a pair of spaced apart charge members and a receiving substrate disposed between the pair of charge members. The method also comprises positioning the first substrate containing particles between the charge members. The method additionally comprises establishing an electrical charge on each of the charge members. And, the method also comprises centrifuging the particle transfer apparatus and the first substrate while the charge members are electrically charged, whereby at least a portion of the particles are transferred to the receiving substrate.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic illustration of a preferred embodiment particle transfer system in accordance with the present invention.

FIG. 2 is a schematic side elevational view of a preferred embodiment particle transfer assembly and a retainer member in accordance with the invention.

FIG. 3 is an exploded schematic illustration of a portion of the preferred assembly depicted in FIG. 2.

FIG. 4 is a schematic side view illustrating the preferred embodiment particle transfer assembly during a particle transfer operation in accordance with the invention.

FIG. 5 is a collection of photographs of a filter containing particulates before a particle transfer operation.

FIG. 6 is a collection of photographs of the filter of FIG. 5 after a particle transfer operation in accordance with the invention.

### DETAILED DESCRIPTION OF THE EMBODIMENTS

Generally, the present invention relates to a particle transfer apparatus for use in an electrostatically-assisted centrifugation method for transferring particles from a first substrate such as a fibrous filter material, textile, or porous polymeric material to a second substrate such as a relatively smooth substrate. Non-limiting examples of the second substrate include silicon wafers and germanium wafers. The smooth substrate or wafer is preferably suitable for use in subsequent analytical methods such as SEM.

The preferred particle transfer apparatus serves to promote transfer of particles retained on a fibrous or porous material to a smooth receiving substrate, which as noted is preferably suitable for use in SEM techniques. The apparatus includes a pair of spaced apart charge members which serve to promote transfer of the particles to the receiving substrate, yet hinder the transfer of fibers from the filter material. A voltage source, preferably external to the apparatus, is used to apply an electrical charge to the charge members. The apparatus further includes a collection of components positioned between the pair of charge members. A particle-embedded first substrate such as a fibrous filter material initially containing the particulates of interest, a screen or other apertured member, and a second substrate such as a silicon wafer to receive at least a portion of the particulates, are preferably positioned between the two charge members. One or more optional spacer members may be located between the pair of charge members as described in greater detail herein.

The particle transfer apparatus is preferably incorporated into a centrifugation component or other apparatus suitable for being subjected to a centrifugation operation. An example of a centrifugation component is a centrifuge tube, microcentrifuge tube, or other component. The particle transfer apparatus is preferably incorporated in the centrifugation component in a particular orientation such that the direction of particle transfer is perpendicular to the axis of rotation of the centrifuge. In a particularly preferred embodiment, the particle transfer apparatus also includes an appropriately shaped retainer member or housing which is sized and shaped to fit within a microcentrifuge tube, for example. The retainer supports the apparatus in a desired orientation during centrifuging.

An electrostatically-assisted centrifugation method described in detail herein, is used to transfer particles from filter material placed within the particle transfer apparatus, to the noted receiving substrate, e.g. the silicon wafer. Once particles have been transferred onto the receiving substrate, the particles can be subjected to a variety of analytical techniques such as SEM.

A potentially important aspect of the invention, besides transfer of particles to a desired substrate, is that the transferred particles represent in some fashion, the previous population of particles initially existing on a first substrate, which is typically a fibrous matrix or other filter media. That is, the particles that are transferred, are preferably retained in their original geometric pattern or distribution, and are proportionate in terms of size, density, or some other characteristic as particles in the original population disposed on the first substrate. Restated, upon transfer to a second substrate, the particles are not re-organized into bands or other new groups or distributions.

The present invention enables transfer of a subset of particles to a microscopy-suitable substrate such that the subset represents the original particle population. The subset potentially has the same characteristics as the original population with respect to the distributions of particle sizes, masses, and shapes and the spatial relationships of the particles. Thus, the particles are not reorganized into collections such as bands that might exhibit different size, mass, and shape distributions and spatial relationships from those of the original collection on the first substrate or filter.

Another important aspect of the invention is the selective placement of particles in an array of deposit areas, such that each deposit area contains a manageable number of particles, typically from about 50 to about 100 particles. The deposit area array and the relatively limited number of particles in each area enable identification and return to the same particle for analysis at a later time or with a different instrument or microscope. This feature is believed to provide a significant advance to the art. In particle analysis, submicron particles are typically repeatedly analyzed after recordal of the position of the deposit area in the array and the approximate location of the particle within the deposit area. And so, providing a technique and related assembly enabling this practice greatly facilitates analytical efforts.

Thus, the preferred embodiment particle transfer apparatus comprises a plurality of charge members, a voltage source, a screen member, one or more optional spacer members, and a retainer housing. A first filter or substrate which is typically fibrous and which contains the particles of interest and a second substrate for receiving the particles are incorporated in the apparatus. The voltage source is used to apply an electrical charge to the charge members. The apparatus and substrates are incorporated in a centrifuge component and subjected to a centrifugation operation. In accordance with the invention establishing a particular electrical charge condition on the charge members and thus on other components of the particle transfer apparatus, promotes particle transfer to a receiving substrate and hinders transport of fragments of the substrate such as fibers or fiber fragments to the receiving substrate. Each of these aspects is described in greater detail herein as follows.

### First Substrate

The first substrate is typically a substrate containing the particles or particulates of interest. As previously noted, this substrate is typically a fibrous filter or textile based material, or a region thereof, but may also be a porous polymeric material such as polyurethane foam. The fibers in filter material are typically quartz fibers and/or glass fibers. Fibrous filters or filter media typically used for collecting airborne particulates are well known in the art and are commercially available from various sources. It will be appreciated that in no way is the present invention limited to such materials or types of substrates. Instead, it is contemplated that the present invention can be used in conjunction with a wide array of substrates including substrates that are free of fibrous matrices or materials.

The first substrate is sized and shaped so that it may be incorporated in the preferred embodiment particle transfer apparatus. Preferably, the first substrate is positioned within a centrifuge component, and so is generally sized and shaped for such positioning. For many applications, the first substrate is cut or otherwise shaped in the form of a circle or disk. The size of the first substrate depends upon the size and configuration of the centrifuge component. When using a 2 ml microcentrifuge tube as the centrifuge component, the first substrate can be in the form of a disk having a diameter of about 8 mm.

### Second Receiving Substrate

The receiving substrate is preferably a member defining a relatively smooth face upon which the particles of interest are collected as the particles are transferred from the first substrate. A silicon or germanium wafer is preferably used for the second substrate. Again, it will be appreciated that nearly any type of substrate can be used as the receiving substrate. The particular characteristics of the receiving substrate generally depend upon the nature of the subsequent analysis to be performed upon particles collected on the receiving substrate. However, for many analytical techniques, it is preferred that the face of the receiving substrate be polished to provide a smooth and uniform face upon which particles are collected.

The second substrate is preferably sized and shaped to be compatible with a centrifuge component. That is, the second substrate is preferably sized and shaped so that it can be positioned within the centrifuge component. For applications in which the centrifuge component is a microcentrifuge tube, the second substrate is then sized and shaped so as to be positioned within the tube during a centrifugation operation. For example, the second substrate can be a 5 mm by 5 mm square shaped smooth wafer.

As explained in greater detail herein, in certain versions of the invention, the receiving substrate or “second substrate” as periodically referred to herein should enable opposite electrical charges to be formed and maintained along its two faces. Generally, selecting a suitable material and forming the second substrate with a sufficient thickness will enable such a condition to occur. For example, for a p(111) crystal silicon wafer, a suitable thickness is about 0.25 mm.

### Charge Members

The charge members can be formed from nearly any material and can be configured in nearly any manner so long as sufficient electrical charge, i.e. a surface charge density, can be formed upon each of the faces of the two members when spaced apart and positioned in the preferred embodiment particle transfer apparatus. Preferably, the members are formed from the same or similar materials, however the invention includes the use of different materials. Poly(tetrafluorethylene) (PTFE) is a preferred material for the members.

The charge members are suitably sized and shaped so that the members can be preferably housed within a centrifuge component. The members are preferably circular shaped. However, it will be understood that in no way is the invention limited to such shapes. Poly(tetrafluorethylene) disks are used in the preferred embodiment apparatus to assist in the movement of particles through the screen member to the receiving substrate. When using a microcentrifuge tube as the centrifuge component, it is generally preferred to use disks having diameters of about 8 mm and 9 mm, for the charge members. As described in greater detail herein, in certain applications it is preferred to use a pair of charge members having faces of different sizes. This practice promotes establishing a voltage potential across the two spaced apart members. Typical thicknesses for each of the charge members is about 1.5 mm.

### Voltage Source

The preferred embodiment particle transfer system includes a voltage source. The voltage source is any device that produces static electricity, or electricity at high voltage and low continuous current. A preferred voltage source is an electrostatic generator or electrostatic device. The voltage source is used to apply an electrical charge to the previously noted pair of spaced apart charge members such that the members become electrically charged and preferably a voltage potential is established across the members. For example, in a preferred method using a preferred particle transfer system, a −30 kV charge is applied to each of two PTFE disks. A negative charge, e.g. −30 kV, is also applied to the receiving (polished) face of the receiving substrate, e.g. the silicon wafer. A second opposite face (unpolished surface) of the silicon wafer has a positive charge as the wafer tends to be retained to the charged PTFE disk positioned alongside the wafer. The silicon wafer can preferably retain opposite charges on the two sides of the wafer because electrostatic charging is a surface phenomenon, and as previously noted, the wafer is preferably thick enough to allow separately charged surfaces to co-exist.

The voltage source can be applied to the pair of spaced apart charge members and the receiving face of the receiving substrate prior to and/or during a centrifugation operation. Preferably, the voltage source is applied momentarily and prior to centrifugation. The period of time during which the voltage source is placed in electrical communication with the charge members and the receiving substrate typically ranges from 0.1 seconds to much longer time periods, such as up to several minutes or longer. The time period is such that sufficient voltage potential can be established across the receiving substrate and the pair of charge members. For many applications, a time period of about 10 seconds is sufficient. The voltages applied to the charge members and the receiving substrate are relatively high, such as at least about −5,000 volts to about −100,000 volts, with a preferred voltage of about −30,000 volts. After sufficient charging, the charge members exhibit measured voltages of at least about −50 volts up to about −500 volts, with a preferred range of from about −200 volts to about −350 volts.

A wide array of voltage sources can be used in conjunction with the present invention. For example, commercially available air ionizing electrostatic generators typically used for controlling static charging in industrial environments may be suitable. An example of such a generator is available from Simco of Hatfield, Pa., under the designation Model ECS30Electrostatic Charging System.

### Screen Member

The preferred particle transfer apparatus also comprises a screen member. The screen member is positioned between the first substrate carrying the particles of interest, and the second or receiving substrate. Generally, a metallic or other suitably formed member having a plurality of apertures extending through the member can be used.

The screen member is preferably sized and shaped to be compatible with a centrifuge component. When using a microcentrifuge tube for the centrifuge component, the screen member is preferably in the form of a 9 mm diameter circular shaped screen having a thickness of about 125 μm. The screen member preferably includes a plurality of openings or apertures extending across its thickness. The apertures are preferably uniformly arranged with respect to one another. The particular sizes of the openings may vary depending upon the characteristics and sizes of the particles to be transferred, however, should be small enough to prevent passage of the fibers or fragments associated with the first substrate. Typical span openings of the screen member are from about 50 μm to 300 μm, with a preferred range being from about 100 μm to about 200 μm. However, it will be appreciated that in no way is the invention limited to these particular sizes of screen openings.

The screen member is also preferably positioned relative to the receiving substrate such that the apertures of the screen member are registered or aligned with deposit areas which may be defined on the receiving substrate. Preferably, the deposit areas are arranged in an array such that the location of a deposit area can be registered as an array cell on the exposed face of the receiving substrate. Once transferred to the receiving substrate, an individual particle may, therefore, be easily located for observation and analysis with different microscopy instruments. A photochemically-etched stainless steel screen with 150 μm diameter holes defined in the screen allows particles to collect in distinct deposit areas on the receiving substrate, e.g. the wafer. An example of such a screen member is a photochemically-etched stainless steel screen commercially available from Buckbee-Mears, Inc. under the trade name MICRO-ETCH®.

### Optional Components

The preferred particle transfer apparatus may also comprise one or more spacer member(s). The spacer member(s) are preferably positioned between the screen member and one of the charge members, and preferably alongside the second or receiving substrate. In a preferred arrangement, the silicon wafer, i.e. the second receiving substrate, is positioned within a copper ring in the apparatus. The ring serves as the spacer component and has the same thickness as the wafer so that no significant air gap exists between the screen and the wafer. A thin layer of adhesive may be used along the interface between the ring and one of the electrically charged members to adhere the ring to the charge member, e.g. the PTFE disk. Similarly, a layer of adhesive may be disposed on an opposite face of the ring, i.e. along the interface of the ring and the screen member to thereby adhere the screen to the ring. This configuration reduces the potential for any shifting of the screen relative to the wafer during centrifugation.

One or more thin adhesive tabs or layers can be used in the preferred embodiment particle transfer apparatus to retain the various components to one another. For example, relatively thin carbon tabs having adhesive coated faces can be used along interfacing regions with the apparatus.

### Retainer or Housing

The preferred particle transfer apparatus is preferably used in conjunction with a retainer for supporting and securing the various components of the apparatus and particularly, retaining the components in particular positions relative to one another and in a desired orientation relative to centrifugation. In a preferred version of the invention, the particle transfer apparatus is used in combination with a cylindrical metallic component machined from a cylindrical specimen mount used for SEM. A wide array of metals can be used for the retainer, however aluminum is preferred. Aluminum rod stock machined to specifications can be used.

### Centrifuge Component

The preferred embodiment particle transfer apparatus is used in conjunction with a centrifuge component and an associated centrifuge system described below. Preferably, the centrifuge component is a centrifuge tube, and in certain applications a 2 ml microcentrifuge tube. The centrifuge tube can be formed from a variety of materials such as stainless steel, or polymers such as polypropylene. Polypropylene or similar polymers may not be preferred for certain applications because polypropylene tends to retain an electrostatic charge, and this could potentially affect the triboelectric behavior of the apparatus. In addition, if formed from stainless steel, the tube shields any electrostatic charge on the microcentrifuge rotor, which is typically also polypropylene. And so, for many applications, a metal centrifuge tube is preferred, and most preferably the metal is stainless steel. For example, a stainless steel tube formed from a stainless steel pipe and fitted with an aluminum end cap can be used. The end cap is preferably in the form of a ring that serves to keep the apparatus centered in the tube and allows for the use of a tool to slide the apparatus into the centrifuge tube. In the event that the centrifuge component is formed from a polymeric material, commercially available 2 ml polypropylene microcentrifuge tubes can be used.

### Centrifugation Operations

A commercially available table top centrifuge may be used to perform the centrifugation operation. Details of such centrifuges, their use and operation are known in the art. A wide range of centrifugation speeds can be used. However, typical centrifugation speeds range from several hundred revolutions per minute (RPM), more preferably from at least about 1,000 RPM, and more preferably from about 2,500 RPM to about 15,000 RPM, with 5,000 RPM being most preferred for many applications. It will be appreciated that in no way is the invention limited to these particular speeds as the invention encompasses speeds less than and greater than these ranges.

### Methods for Transferring Particles

Various methods for transferring particles retained in or on a first substrate which as noted is typically of a fibrous material, to a second substrate are provided. The two substrates are positioned between the two charge members of the particle transfer apparatus, and preferably such that the screen member is disposed between the two substrates. Generally, after appropriate placement and positioning of the substrates within the particle transfer apparatus, the charge members of the apparatus are electrically charged as described herein. The apparatus and substrates are then engaged or otherwise placed in association with a retainer member and positioned in a centrifuge component. The particle transfer apparatus is positioned such that during centrifugation, the direction of particle transfer is perpendicular to the axis of rotation of the components. And, preferably, the apparatus is positioned such that the direction of transfer of particles is collinear with the centrifugal force at any moment during centrifugation. Thus, the centrifugal force promotes displacement of particles from the first substrate to the receiving substrate. The charged faces of the charge members and the charged receiving face of the receiving substrate induce charges on other components in the assembly and further promote transfer of particles from the first substrate to the receiving substrate. The screen member disposed between the two substrates precludes or at least significantly reduces passage of fibers or fragments from the first substrate to the receiving substrate.

The invention includes numerous variations in these methods. For example, it is contemplated that the charge members could be electrically charged after positioning of the apparatus within the centrifuge component. It is also contemplated that charging of the charge members could be performed during centrifugation or immediately prior thereto.

After centrifugation, at least a portion or a subset of the particles initially associated with the first substrate will then be collected or disposed on the second substrate. As noted, the particles collected on the second substrate preferably retain one or more characteristics associated with their previous grouping on the first substrate.

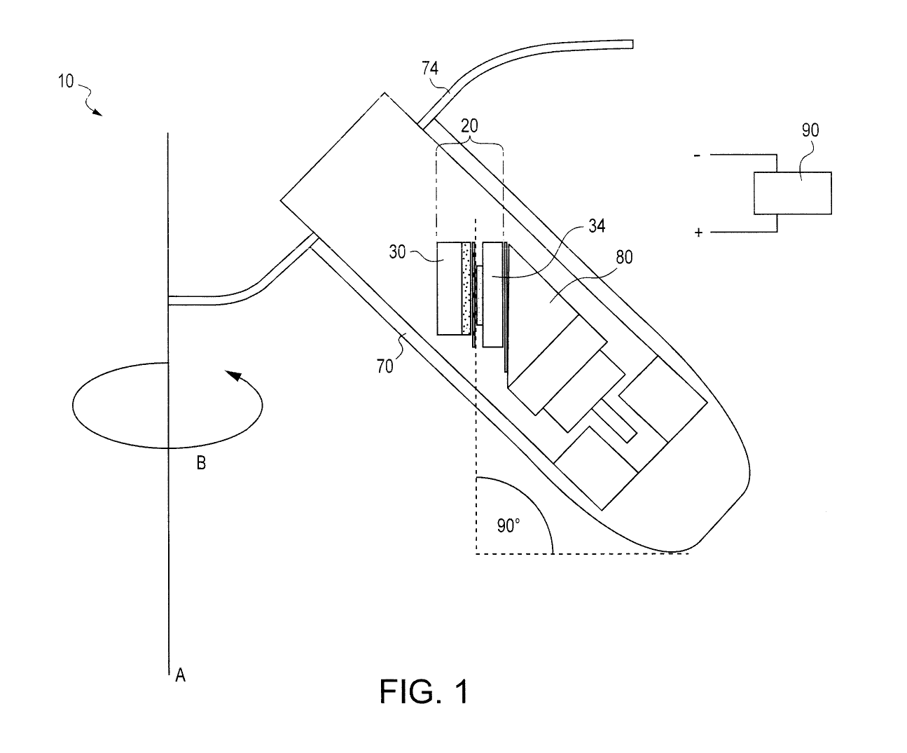

FIG. 1 schematically illustrates a preferred embodiment particle transfer system 10 in accordance with the present invention. The particle transfer system 10 comprises a particle transfer apparatus 20, a centrifugation component 70, which as depicted is in the form of a centrifuge tube, a retainer 80 for supporting the apparatus 20 within the centrifugation component 70, and a voltage source 90. The centrifugation component 70 is supported and retained by a rotor 74 which during a centrifugation operation, rotates about axis A in the direction of arrow B for example. It will be appreciated that the present invention is not limited to centrifugations in the direction of arrow B, and includes centrifugations in a direction opposite from arrow B. In addition, the invention includes centrifugations about axes different from axis A.

The particle transfer apparatus 20 includes a pair of spaced apart charge members 30 and 34. As explained in greater detail herein, an electrostatic charge is applied to each of the members and preferably a voltage potential is established across the charge members 30 and 34, by the voltage source 90. Additional components including a filter or substrate containing particles to be transferred, and a receiving substrate for receiving the particles, are positioned between and preferably parallel with the charge members 30 and 34. Preferably, a voltage potential is also applied to the receiving substrate by the voltage source 90.

FIG. 1 illustrates a preferred aspect of the invention. Upon incorporating the particle transfer apparatus 20 in the centrifugation component 70, it is preferred that the apparatus 20 be oriented such that the charge members 30 and 34 and other components disposed therebetween, are oriented within planes that are each generally parallel with the axis of rotation A of the centrifuge. For the particular configuration depicted in FIG. 1, since the centrifugation component 70 is suspended from the rotor 74 at an angle of about 45° with respect to the axis A, the retainer 80 is configured such that when it is positioned and secured within the centrifugation component 70, the particle transfer apparatus 20 is preferably positioned as described herein. Although the invention is not limited to any particular size or geometry, for the representative preferred embodiment system 10 depicted in FIG. 1, the distance between axis A and the outermost portion of the centrifugation component 70 (taken along a line transverse to the axis A), is about 8.35 cm.

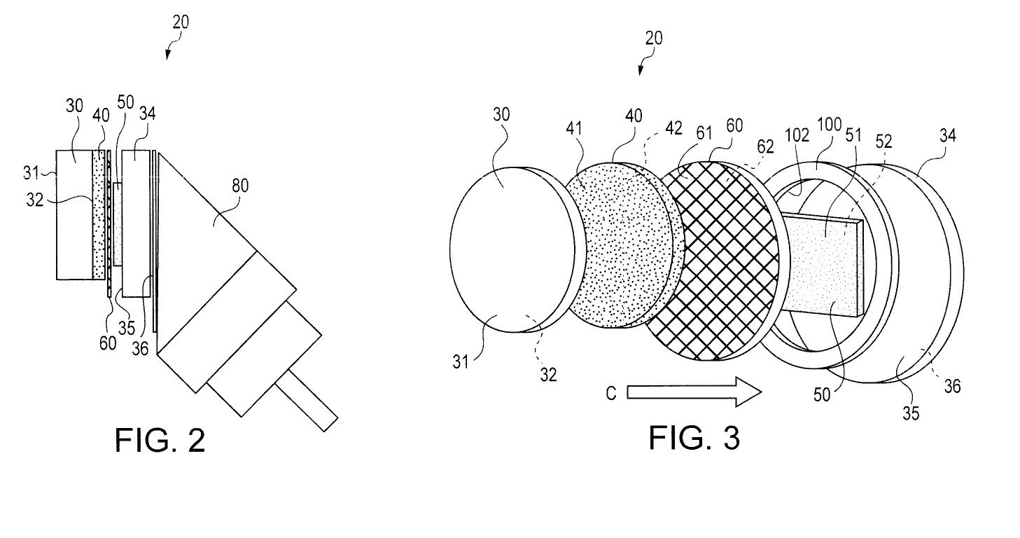

FIG. 2 illustrates the particle transfer apparatus 20 in greater detail. The apparatus 20 is shown secured to and supported by the retainer 80. The apparatus 20 includes the previously noted charge members, and specifically the first charge member 30 and the second charge member 34. The apparatus 20 also includes a screen member 60 disposed between the charge members 30 and 34. The apparatus also includes a receiving substrate 50 disposed between the screen member 60 and the charge member 34. Preferably, the receiving substrate 50 is positioned immediately adjacent to the outermost charge member 34. References to “outer” or “inner” (or “outermost” or “innermost”) are with regard to the axis of rotation A when the apparatus 20 is appropriately positioned in a centrifuge component. Each charge member defines a pair of oppositely directed faces. Specifically, the inner charge member 30 defines an inwardly directed face 31 and an outwardly directed face 32. And, the outer charge member 34 defines an inwardly directed face 35 and an outwardly directed face 36. The receiving substrate 50 is preferably positioned along the inwardly directed face 35 of the outer charge member 34. The apparatus 20 accommodates a first filter member 40, which is typically fibrous, which is positioned between the first charge member 30 and the screen member 60, and inward of the second receiving substrate 50. The face of the filter member 40 that contains the bulk of the particulates is directed toward the screen. Thus, upon placement of the apparatus 20 in the centrifuge component 70 (illustrated in FIG. 1), the receiving substrate 50 is disposed outwardly relative to the first filter member 40.

In certain applications, it is preferred that the outer charge member 34 be larger than the inner charge member 30. Specifically, this preference refers to the inwardly directed face 35 of the outer charge member 34 having a greater surface area than the outwardly directed face 32 of the inner charge member 30. For many applications, it is preferred that the surface area of the inwardly directed face of the outer charge member be from about 1.1 to about 2.0 times the surface area of the outwardly directed face of the inner charge member, with about 1.4 times being most preferred. However, it will be understood that in no way is the invention limited to these particular size relationships. A difference in surface area between these faces promotes a voltage difference between the faces.

FIG. 3 is an exploded view of the preferred embodiment particle transfer apparatus 20 illustrating the use of an optional spacer member 100. Upon appropriate placement of the apparatus 20 in a centrifugation system and initiation of a centrifugation operation, particles or particulates such as existing on the filter member 40 are transferred in the direction of arrow C to the receiving substrate 50. FIG. 3 also further illustrates representative preferred shapes for the various components, e.g. the pair of charge members 30, 34, and the screen member 60, are each typically in the form of circular disks. The receiving substrate 50 could also be circular shaped, however is depicted as square shaped in FIG. 3. The filter member 40 is depicted as having a circular disk shape. The spacer member 100 preferably defines an open interior region defined by an opening 102 extending through the member 100. Preferably, the opening 102 is sized and shaped so as to receive the substrate 50 as shown in FIG. 3. Furthermore, the member 100 has a thickness sufficient to accommodate the receiving substrate 50. Preferably, the thickness of the spacer member 100 is equal to or greater than the thickness of the receiving substrate 50. As noted, the first charge member 30 defines an inner face 31 and an oppositely directed outer face 32. And, the second charge member 34 defines an inner face 35 and an oppositely directed outer face 36. Similarly, the filter member 40 defines an inner face 41 and an oppositely directed outer face 42, which contains the bulk of the particles. The screen member 60 defines an inner face 61 and an oppositely directed outer face 62. The receiving substrate 50 defines an inner face 51 and an oppositely directed outer face 52.

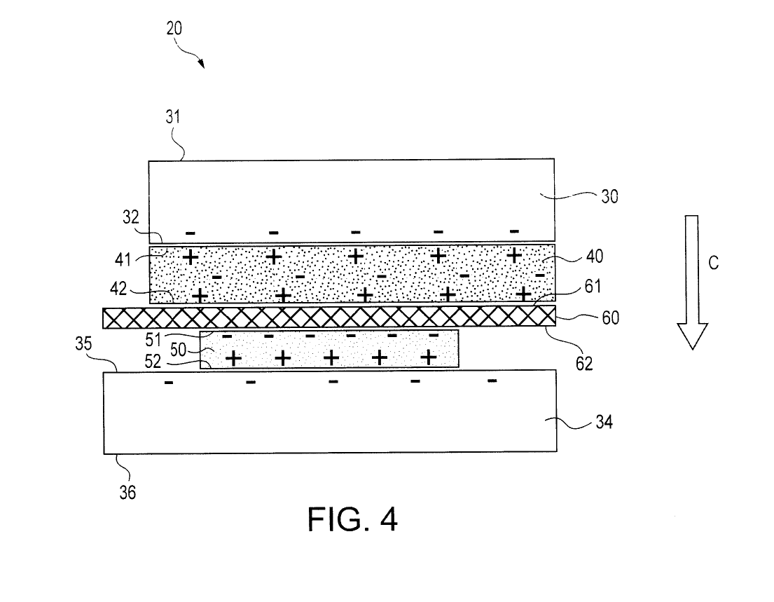

FIG. 4 is a schematic side view of the preferred embodiment particle transfer apparatus 20 illustrating a preferred charge state in accordance with the present invention. Thus, upon applying an electrostatic charge on each of the charge members 30 and 34 and the receiving face of the receiving substrate, by use of the voltage source, such as source 90 depicted in FIG. 1, the various components adopt a charged state as schematically shown in FIG. 4. Specifically, the outer face 32 of the innermost charge member 30 exhibits a negative charge. The inner face 41 of the filter member 40 exhibits a positive charge, thereby inducing a negative charge state generally on fibers within the interior of the filter member 40. The negative charge state on the filter fibers induces a positive charge on the particles, which are collected at the outer face 42 of filter member 40. The inner face 51 of the receiving substrate 50 exhibits a negative charge and the outer face 52 of the receiving substrate 50 exhibits a positive charge. The inner face 35 of the second charge member 34 exhibits a negative charge. Upon incorporation of the apparatus 20 in a centrifugation component and upon initiation of a centrifugation operation, particles with an induced positive charge (as well as uncharged particles) are transferred from the filter member 40 to the negatively charged receiving substrate 50 and thus are transported generally in the direction of arrow C. The screen member 60 prevents or at least significantly reduces the passage of fibers from the filter member 40 to the receiving substrate 50, while allowing transfer of particles therethrough.

Contact between the inner face 41 of the filter 40 and the outer face 32 of the inner charge member 30 reinforces and promotes charge separation between the fibers of filter 40 (charged negative) nearest the outer face 42 and the particles (charged positive) at the outer face 42 of filter 40. Charge separation between the positively charged particles and the negatively charged inner face 51 of receiving substrate 50 favors movement of particles (including uncharged particles) through the screen 60 to the receiving substrate 50.

### Examples

Particles were collected in 150 μm diameter deposit areas on a target substrate in a preferred embodiment particle transfer apparatus. Deposit areas were identified on a receiving substrate such that the location of a deposit area containing a specific particle could be registered as an array element, thereby allowing for the particle to be easily located for subsequent observation and analysis among different microscopy instruments.

Specifically, a preferred embodiment particle transfer apparatus was inserted inside a 2 ml polypropylene microcentrifuge tube. The apparatus included a square section of silicon wafer as a smooth target substrate and a circular section of a fibrous filter sandwiched between two circular poly(tetrafluoroethylene) (PTFE) disks. Between the wafer and the filter was positioned a stainless-steel screen with 150 μm photochemically-etched holes that allowed particles to pass to the wafer but not large fibers from the filter. As described herein, the PTFE disks were used to create an electrostatic condition on the filter and wafer that promoted the movement of particles to the wafer during centrifugation but which hindered the movement of unwanted quartz fibers or fragments that were small enough to otherwise pass through the stainless steel screen.

The apparatus included a cylindrical aluminum body machined from a commercially available specimen mount used for SEM. The silicon wafer was placed within a copper-beryllium ring and on a 9 mm diameter PTFE disk, which is attached to a 45° oriented surface of the aluminum body by a sticky carbon tab. Above the wafer was positioned a 9 mm diameter screen followed by an 8 mm diameter filter and then an 8 mm diameter PTFE disk.

The components were positioned as shown in FIG. 1. As previously explained, FIG. 1 illustrates a preferred orientation for the apparatus and its placement in the microcentrifuge tube. Stacking of components at a 45° angle on the aluminum body positions the filter and the wafer at a 90° angle in the microcentrifuge tube so that particles migrate evenly to the wafer during centrifugation.

For inducing electrostatic charges on the wafer and filter, −30 kV was applied separately to the PTFE disks and the polished surface of the wafer for 10 seconds. The charge was delivered by a commercially available air-ionizing electrostatic generator designed for controlling static charging in industrial environments (Simco Model ECS30 Electrostatic Charging System). From field meter measurements, the potential on the 9 mm PTFE disk was 100 V greater than the potential on the 8 mm disk. The calculated surface charge densities were 1.1×10⁻⁷ coulombs m⁻² and 0.78×10⁻⁷ coulombs m⁻² for the 9 mm disk and 8 mm disk, respectively. Thus, the charge density on the 9 mm disk was about 1.4 times greater than on the 8 mm disk. The total charge is 1.8 times higher on the 9 mm disk.

PTFE is ideally suited for separating and stratifying static charges in the preferred embodiment apparatus, for a number of reasons. First, the polymer has a large work function (5.75 eV) relative to Au and, therefore, a relatively large amount of work is required to remove an electron. Second, it is the negative end member of the triboelectric series for synthetic and natural polymers. Third, PTFE tends to retain its negative charge for an extraordinary long time and long enough for the duration of centrifugation. Both quartz (SiO₂) and the p(111) crystal Si wafer have smaller work functions than PTFE (5.00 eV and 4.60 eV, respectively) and would, therefore, gain a positive charge when in contact with negatively charged PTFE. Evidence of the positive charging of the wafer and the filter was observed. The filter section and Si wafer firmly stuck or were pinned to the PTFE disks when turned upside down. An added benefit of electrostatically “pinning” the wafer and filter to their respective PTFE disks is that the wafer and filter remain securely in place at a 90° angle in the centrifuge.

The induced positive charge on the filter from contact with the clean side of the filter with the charged PTFE disk reinforces the charge separation between particles and filter fibers. While quartz fibers in contact with the charged PTFE disk are charged positive, quartz fibers at the side of the filter loaded with particles, i.e. furthest away from the PTFE disk, acquires a negative charge. To balance the negative charge on the quartz fibers, the particles acquire a positive charge. During centrifugation, electrostatic conditions favor the movement of positively charged particles through the screen to the wafer that has been charged negative.

An unwanted effect of the centripetal force on the filter during centrifugation is the fragmentation of the fibers as the filter is compressed against the screen. If fiber fragments in the size range of the atmospheric particles move to the wafer, they may be mistaken for atmospheric particles. The electrostatic conditions that are favorable for moving positively charged particles to the negatively charged wafer, as described herein are however, unfavorable for moving the negatively charged fiber fragments to the wafer.

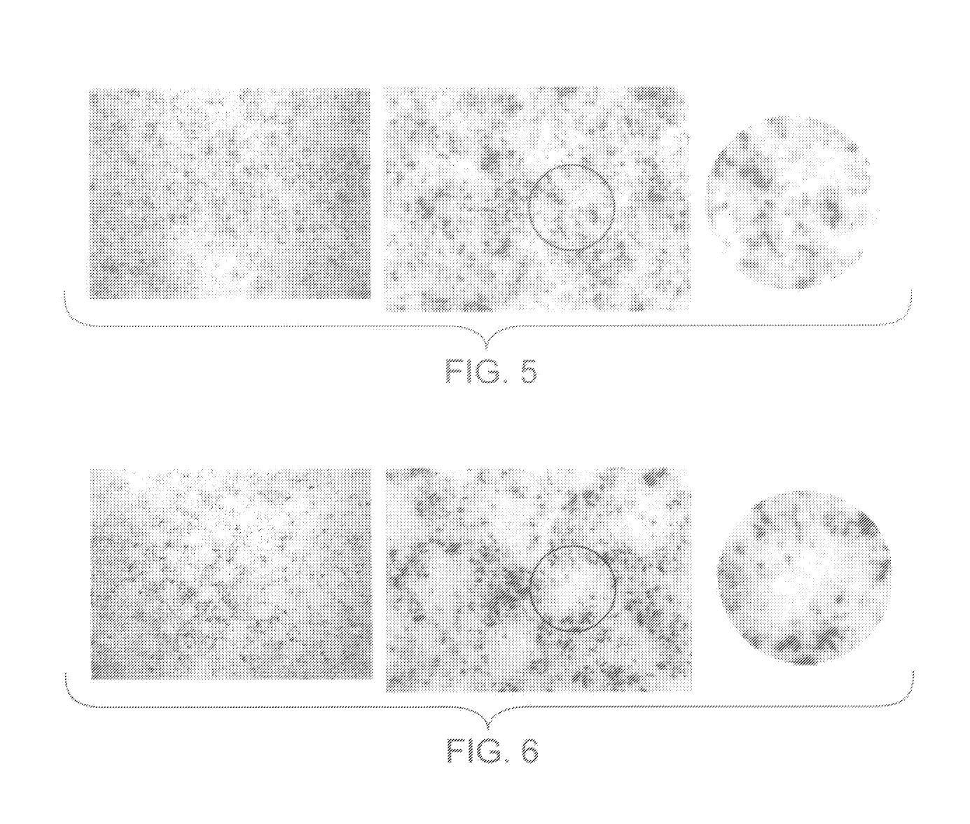

FIG. 5 illustrates three different magnifications of a face of a fibrous filter containing particulates. The magnifications increase from left to right. FIG. 5 illustrates the filter face prior to transfer of particles. FIG. 6 illustrates the same filter face, at increasing magnification from left to right, after transfer of particles. These figures illustrate that transfer of particulates includes transfer of only a portion of particulates, whereby a remaining population of particulates is left relatively undisturbed on the filter.

Although the present invention has been primarily described in terms of a relatively small apparatus and system which is useful for laboratory applications, it will be appreciated that the invention includes significantly larger and/or scaled up versions. For example, the present invention is contemplated to find wide use and application in industry in which high volume and throughputs are desired.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present invention includes any and all combinations of components or features of the embodiments described herein.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. A particle transfer apparatus comprising:
a first charge member defining a first face, the first member adapted for retaining an electrical charge along the first face;
a second charge member defining a second face directed toward the first face of the first charge member, the second member adapted for retaining an electrical charge along the second face, the second charge member spaced from the first charge member;
a screen member disposed between the first charge member and the second charge member, the screen member defining a plurality of apertures extending through the screen member;
a receiving substrate disposed between the screen member and the second charge member, the receiving substrate defining a receiving face adapted for retaining an electrical charge along the receiving face and directed toward the first face of the first charge member.

2. The particle transfer apparatus of claim 1 further comprising:
a filter member containing particles, the filter member disposed between the screen member and the first charge member.

3. The particle transfer apparatus of claim 1 wherein the surface area of the second face is greater than the surface area of the first face.

4. The particle transfer apparatus of claim 1 wherein at least one of the first charge member and the second charge member includes poly(tetrafluorethylene).

5. The particle transfer apparatus of claim 1 wherein the screen member defines a plurality of openings extending through the screen member, each opening having a span within a range of from about 50 μm to about 300 μm.

6. The particle transfer apparatus of claim 1 wherein the screen member is formed from metal.

7. The particle transfer apparatus of claim 1 wherein the receiving substrate includes at least one of silicon and germanium.

8. A particle transfer system comprising:
a centrifuge component;
a particle transfer apparatus disposed within the centrifuge component, the particle transfer apparatus including a pair of spaced apart charge members adapted for retaining an electrical charge, and a receiving substrate adapted for retaining an electrical charge and disposed between the pair of charge members;
a centrifugation system including provisions for performing a centrifugation operation upon the centrifuge component and the particle transfer apparatus.

9. The particle transfer system of claim 8 wherein the centrifuge component is a centrifuge tube and the particle transfer apparatus is housed within the centrifuge tube.

10. The particle transfer system of claim 8 further comprising:
a retainer disposed in the centrifuge component, the retainer sized, shaped, and configured to support and retain the particle transfer apparatus and secure the apparatus within the centrifuge component.

11. The particle transfer system of claim 8 further comprising:
a voltage source.

12. The particle transfer system of claim 8 wherein at least one of the charge members includes poly(tetrafluorethylene).

13. The particle transfer system of claim 8 wherein the particle transfer apparatus further includes a screen member disposed between the pair of charge members.

14. The particle transfer system of claim 13 wherein the screen member defines a plurality of openings extending through the screen member, each opening having a span within a range of from about 50 μm to about 300 μm.

15. The particle transfer system of claim 13 wherein the screen member is formed from metal.

16. The particle transfer system of claim 8 wherein the receiving substrate includes silicon or germanium.

17. A method for transferring particles from a first substrate to a second receiving substrate, the method comprising:
providing a particle transfer apparatus including a pair of spaced apart charge members and a receiving substrate disposed between the pair of charge members;
positioning the first substrate containing particles between the charge members;
establishing an electrical charge on each of the charge members;
establishing an electrical charge on the receiving surface of the receiving substrate;
centrifuging the particle transfer apparatus and the first substrate while the charge members and the receiving substrate are electrically charged, whereby at least a portion of the particles are transferred to the receiving substrate.

18. The method of claim 17 further comprising:
providing a centrifugation system including a centrifuge component and provisions for centrifuging, wherein prior to centrifuging, the particle transfer apparatus is positioned within the centrifuge component.

19. The method of claim 18 wherein the particle transfer apparatus is positioned in the centrifuge component such that upon centrifuging the particle transfer apparatus about an axis of rotation, the charge members and the receiving substrate are each oriented within a plane parallel to the axis of rotation.

20. The method of claim 17 further comprising:
positioning a screen member between the first substrate containing particles and one of the charge members.
